(19) United States
(12) Patent Application Publication
(10) Pub. No.: US 2020/0137280 A1
(43) Pub. Date: Apr. 30, 2020

(54) Optical Jitter Estimation

(71) Applicant: The Government of the United States of America, as represented by the Secretary of the Navy, Arlington, VA (US)

(72) Inventor: Adam J. Yingling, Washington, DC (US)

(21) Appl. No.: 16/667,304

(22) Filed: Oct. 29, 2019

Related U.S. Application Data
(60) Provisional application No. 62/751,942, filed on Oct. 29, 2018.

(51) Int. Cl. H04N 5/232

(52) U.S. Cl. CPC H04N 5/2329; H04N 5/23254

(57) ABSTRACT

According to one aspect of the invention, a method of estimating optical jitter, the methods comprising the steps of: capturing an image in a series of consecutive frames; iteratively characterizing one or more optical parameters of the captured image over the consecutive frames; and based on the one or more optical parameters, executing time domain analysis to decompose optical disturbance into drift and jitter.

### RELATED APPLICATIONS

This application claims the benefit of U.S. Provisional Application No. 62/751,942 filed Oct. 29, 2018, which is hereby incorporated herein by reference.

### FEDERALLY-SPONSORED RESEARCH AND DEVELOPMENT

The United States Government has ownership rights in this invention. Licensing inquiries may be directed to Office of Technology Transfer, US Naval Research Laboratory, Code 1004, Washington, D.C. 20375, USA; +1.202.767.7230; techtran@nrl.navy.mil, referencing NC 107332.

### FIELD OF INVENTION

The present invention relates generally to optical imaging and projection, and more particularly to optical jitter estimation.

### BACKGROUND

Image quality, commonly measured in National Imagery Interpretability Rating Scale (NIIRS), is a key optical performance metric that is very sensitive to jitter. The image quality of a system decreases as jitter increases. Thus, in order to maintain image quality, the system should minimize jitter.

In this work, optical jitter is defined as the motion of a beam of light across a system's instantaneous field of view (iFOV) during the nominal time window in which the image was taken; commonly referred to as the integration time; tᵢₙₜ. For examples used herein, a 3 millisecond window is assumed; tᵢₙₜ=3 ms.

Conventional methods to account for optical jitter typically use inertial measurement units (IMUs) to measure inertial disturbances and augment those measurements with analytical models to predict how those disturbances perturb the optical system and degrade its image quality. Inertial instrumentation typically includes accelerometers, rate sensors, and position sensors. Analytical models include CAD models, finite element models, and optical models.

The predictive ability of the state-of-the-art is dependent on the locations of measurement, the sensitivity of the instruments, the accuracy of each analytical model, how well the models are integrated together, and the control scheme employed. Much time and expense can be invested into developing a system that accurately predicts how the image quality will degrade for a set of disturbance sources. Typically only a subset of disturbances will be accurately measured, modeled, and controlled out of an active optical system.

### SUMMARY OF INVENTION

For a single beam of light, jitter manifests itself as a smeared beam spot in the image. When represented visually, the beam spot looks elongated because the location of the beam translated across the focal plane array (FPA) during the integration time.

According to one aspect of the invention, a method of estimating optical jitter, the methods comprising the steps of: capturing an image in a series of consecutive frames; iteratively characterizing one or more optical parameters of the captured image over the consecutive frames; and based on the one or more optical parameters, executing time domain analysis to decompose optical disturbance into drift and jitter.

Optionally, the one or more optical parameters include a centroid of the image.

Optionally, the image is an image of an impinging laser.

Optionally, the step of stacking consecutive frames and determining centroid movement over a time step defined by a frame rate and number of images stacked.

Optionally, the method includes the step of isolating the captured image by cropping to an area the laser image will appear, applying a threshold to the cropped image, and utilizing binary masking to isolate content in the captured image.

Optionally, the step of executing time domain analysis includes determining line of sight disturbance by measuring changes in centroid location and shape of a laser spot in the captured image.

Optionally, drift is found as a linear fit through an integration window defined by a subset of sequential frames.

Optionally, jitter is found by removing drift and computing a root-mean square value of residual offsets from drift.

Optionally, the method uses a rolling integration window technique.

Optionally, the method includes the step of obtaining spectral responses of the one or more optical parameters.

Optionally, the method includes the step of correlating the spectral responses with known modes to identify sources of disturbance.

Optionally, the method includes the steps of storing drift and jitter in arrays for each of a plurality of rolling integration windows; computing an average and standard deviation of drift and jitter from the arrays; and determining success or failure of pointing stability for an imaging system by comparing the average plus a predetermined multiple of the standard deviation to a predetermined threshold.

The foregoing and other features of the invention are hereinafter described in greater detail with reference to the accompanying drawings.

### BRIEF DESCRIPTION OF THE DRAWINGS

FIG. 1 shows an exemplary laser image;

FIG. 2 shows an exemplary laser image with calculated image characteristics of interest;

FIG. 3 shows an exemplary image stack with a laser image sweared over approximately 3 ms;

FIG. 4 shows a Plot of Line of Sight (LoS) disturbance magnitude as seen on an exemplary focal plane;

FIG. 5 shows a plot of drift;

FIG. 6 shows a plot of jitter;

FIG. 7 shows a plot of the frequency response of the disturbance;

FIG. 8 shows an exemplary test set-up as used for the examples given herein.

### DETAILED DESCRIPTION

The exemplary Fast Image Plane Spectral (FIPS) analysis technique is described herein and is used to discover and identify all disturbance sources that degrade image quality. Exemplary FIPS measurement techniques use a high speed focal plane array (FPA) to record the motion of a laser beam. The beam propagates off of all the optical surfaces to where the FPA images the beam's spot. All disturbances in the system's line of sight (LOS) are captured directly on the image plane where images are formed and from which image quality is assessed. This is the location that matters the most.

The beam spot is analyzed frame by frame to determine sub-pixel motion of the spot due to disturbances. Disturbance sources are identified by their spectral content; e.g. structural modes, electrical noise, etc.

Cost decreases and performance improvements in computing power, FPA speeds, and lasers have made this approach an affordable and effective diagnostic tool in the lab.

Unlike exemplary techniques, conventional techniques generally cannot assess performance directly where images are formed. Most conventional techniques cannot assess all disturbance sources simultaneously. Typically disturbances are optically convolved together in an image making them difficult to identify and quantify. However, by using a point source, these disturbances are easily separated using fast Fourier transforms. Most disturbance sources have unique spectral content, allowing one to discern what disturbances are degrading image quality. Exemplary techniques are able to detect very low-level disturbances with sub-microradian accuracy. Exemplary techniques provide a truth source for pointing stability and can be implemented inside or outside the lab. If integrated into a system, exemplary techniques can allow for self-diagnosis and self-calibration of an imaging system with on-board image processing capability.

The FIPS measurement technique may use a high speed focal plane array (FPA) recording at, for example, 1500 FPS with an integration time of 200 us to track the motion of a laser beam due to ALL disturbances (drift and jitter) within the system's line of sight (LoS). This capture speed eliminates individual frame smearing due to disturbances. The FIPS analysis FPA preferably has a smaller field of view than the flight FPA so that it can image continuously at high frame rate over the EDU's step, settle, and imaging cadence (Right). In an exemplary embodiment, the laser spot size is about 60 pixels (480 ums), which is approximately 10% of the exemplary FIPS camera's field of view. It should be noted that size can be varied to adjusting Laser intensity.

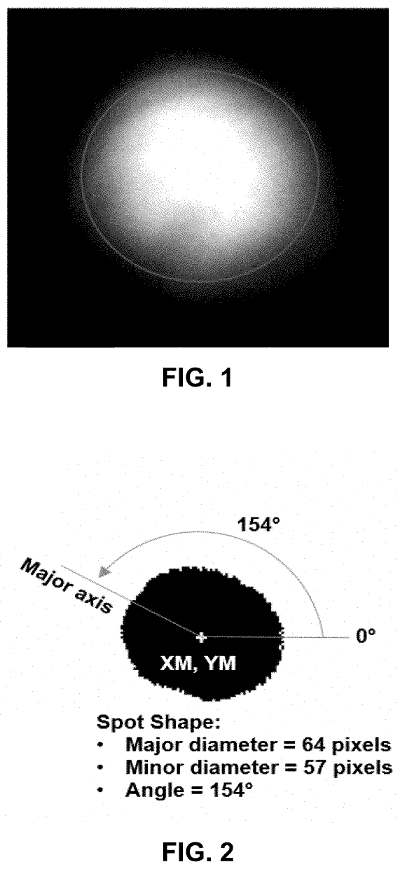

Referring first to FIGS. 1-3, in an exemplary embodiment, the laser image is captured in a series of consecutive frames. Iteratively for each frame, the laser spot is characterized. In particular, the centroid and shape of the laser image is determined. Next, frames are stacked to produce a smear resulting from laser image movement over time. In an exemplary embodiment, frames are stacked to produce an approximately 3 ms window of smear (in the exemplary embodiment described herein, a frame is 0.67 ms, so, for example, 5 frames are stacked).

Although many ways of isolating and characterizing the laser image will be known to those skilled in the art, one exemplary way includes cropping the image to the area the laser image will appear, applying a threshold to the cropped image, and utilizing binary masking to isolate the laser image.

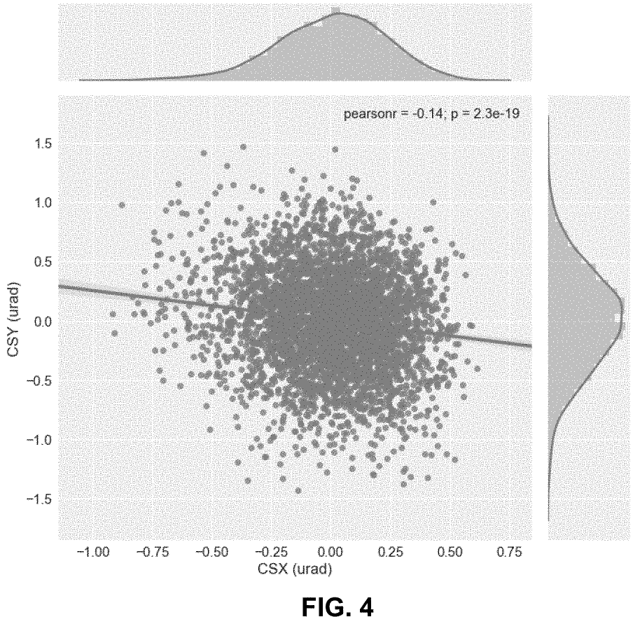

Referring now to FIG. 4, based on the stacked images, the line of sight (LoS) disturbance can be determined by the changes in the centroid location and shape of the laser spot. FIG. 4 shows an exemplary plot of LoS disturbance magnitude as seen on the focal plane.

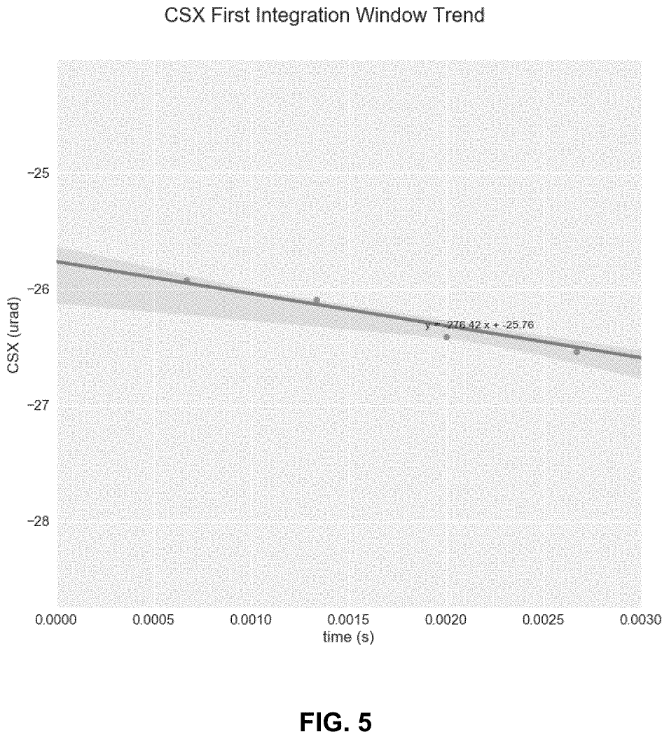

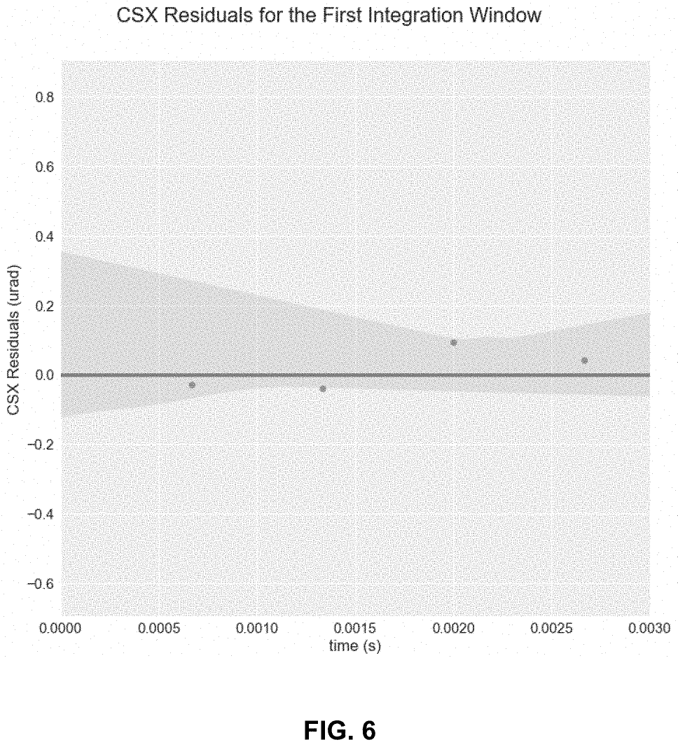

Referring now to FIGS. 5 and 6, execution of an automated time domain analysis can be used to decompose disturbances into drift and jitter components. In particular, as alluded to above, the centroid data is used to quantify pointing stability in terms of drift and jitter. A shown in FIG. 5, drift can be found as the linear fit through an integration window of, for example, 3 ms. As shown in FIG. 6, drift can be removed to find jitter, the root-mean square value of the residual offsets from drift. A “rolling” integration window technique is used to ensure statistical significance. In other words, the next window contains the same data points except the last data point is dropped and the next frame's data point is added.

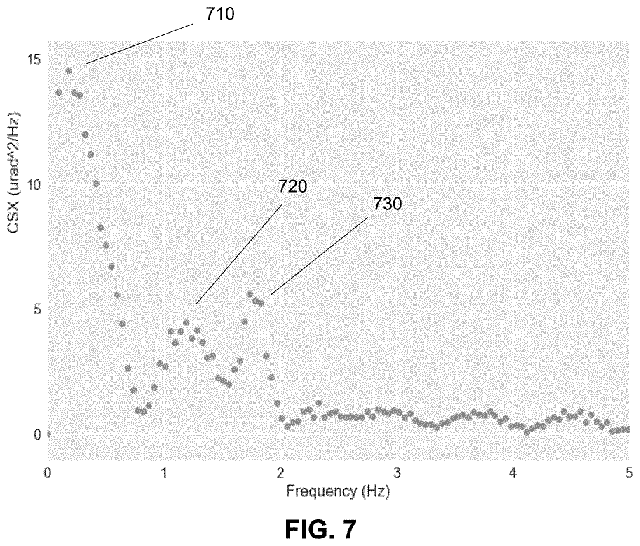

Next, as shown in FIG. 7, execution of an automated frequency domain analysis using a Fourier Transform of data is used to obtain spectral responses. These spectral responses are then correlated with known modes to identify sources of disturbance. In the example of FIG. 7, the first peak at 710 can be identified as caused by air scintillation. The second peak, at 720 can be identified as “bus” pitch, while the third peak, at 730, can be identified as “bus” yaw.

As mentioned above, over a given integration window, a disturbance is the resultant magnitude shift from origin (all effects combined); drift is the constant rate of change across the integration window (linear fit of disturbance); and jitter is the residual motion after drift is removed (residuals from the linear fit).

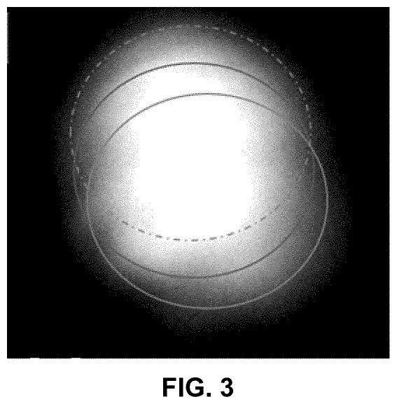

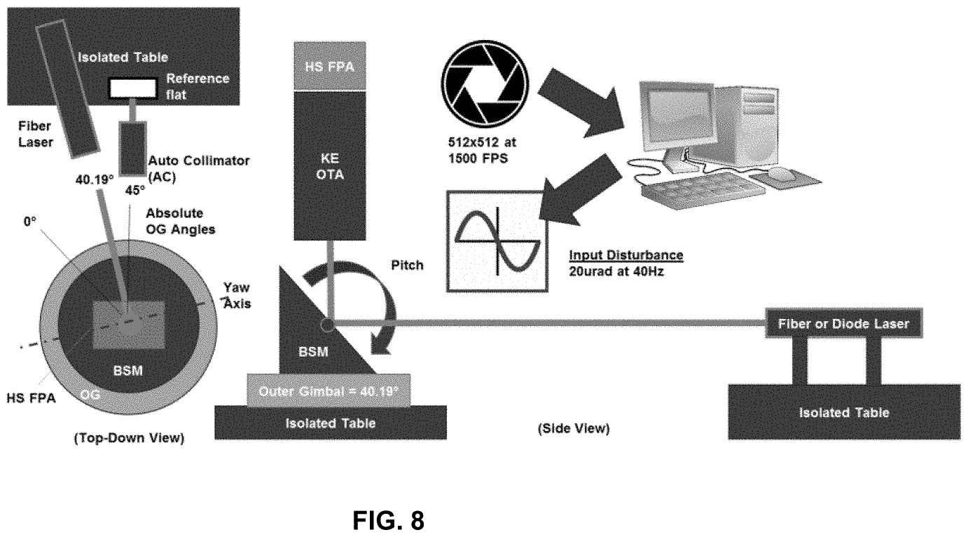

In the example described above with reference to the accompanying figures, the smearing shown in FIG. 3 was generated by commanding a beam steering mirror (BSM) to oscillate with a 20 urad mechanical amplitude at a frequency of 40 Hz. This setup is illustrated in FIG. 8 and shows that a fiber-laser beam was reflected off the BSM into the system and captured by a high speed (HS) focal plane array (FPA) running at frame rate of 1500 frames per second (FPS). An outer gimbal was slewed and the response of a Newport table “bus” was measured. No control was applied for this test. Three responses, as shown in FIG. 7, were detected.

In exemplary systems, each drift and jitter measurement is stored in arrays for each rolling integration window: about 80 samples of drift in X for each imaging interval; about 80 samples of drift in Y for each imaging interval; about 80 samples of jitter in X for each imaging interval, and about 80 samples of jitter in Y for each imaging interval. The average and standard deviation of drift and jitter can be calculated from those arrays. These values may be used in exemplary systems to determine success or failure of pointing stability for an imaging system. In particular, an example success criteria may be that drift and jitter must be less than 1 μrad when measured over the 3 ms integration window and do so 95% of the time or better. Therefore, the average plus two standard deviations should be less than 1 μrad. Note that this discussion is all single sided: 1 μrad is allowed from origin while 2 μrad is allowed peak to peak.

Although the invention has been shown and described with respect to a certain embodiment or embodiments, it is obvious that equivalent alterations and modifications will occur to others skilled in the art upon the reading and understanding of this specification and the annexed drawings. In particular regard to the various functions performed by the above described elements (components, assemblies, devices, compositions, etc.), the terms (including a reference to a “means”) used to describe such elements are intended to correspond, unless otherwise indicated, to any element which performs the specified function of the described element (i.e., that is functionally equivalent), even though not structurally equivalent to the disclosed structure which performs the function in the herein illustrated exemplary embodiment or embodiments of the invention. In addition, while a particular feature of the invention may have been described above with respect to only one or more of several illustrated embodiments, such feature may be combined with one or more other features of the other embodiments, as may be desired and advantageous for any given or particular application.

What is claimed is:

1. A method of estimating optical jitter, the methods comprising the steps of:
capturing an image in a series of consecutive frames;
iteratively characterizing one or more optical parameters of the captured image over the consecutive frames; and
based on the one or more optical parameters, executing time domain analysis to decompose optical disturbance into drift and jitter.

2. The method of claim 1, wherein the one or more optical parameters include a centroid of the image.

3. The method of claim 1, wherein the image is an image of an impinging laser.

4. The method of claim 1, further comprising the step of stacking consecutive frames and determining centroid movement over a time step defined by a frame rate and number of images stacked.

5. The method of claim 1, further comprising the step of isolating the captured image by cropping to an area the laser image will appear, applying a threshold to the cropped image, and utilizing binary masking to isolate content in the captured image.

6. The method of claim 1, wherein the step of executing time domain analysis includes determining line of sight disturbance by measuring changes in centroid location and shape of a laser spot in the captured image.

7. The method of claim 1, wherein drift is found as a linear fit through an integration window defined by a subset of sequential frames.

8. The method of claim 1, wherein jitter is found by removing drift and computing a root-mean square value of residual offsets from drift.

9. The method of claim 1, using a rolling integration window technique.

10. The method of claim 1, further including the step of obtaining spectral responses of the one or more optical parameters.

11. The method of claim 10, further comprising the step of correlating the spectral responses with known modes to identify sources of disturbance.

12. The method of claim 1, further comprising the steps of:
storing drift and jitter in arrays for each of a plurality of rolling integration windows;
computing an average and standard deviation of drift and jitter from the arrays; and
determining success or failure of pointing stability for an imaging system by comparing the average plus a predetermined multiple of the standard deviation to a predetermined threshold.
